(19) United States
(12) Patent Application Publication
(10) Pub. No.: US 2016/0011790 A1
(43) Pub. Date: Jan. 14, 2016

(54) SYSTEMS AND METHODS TO ENABLE ACCESS TO A HOST MEMORY ASSOCIATED WITH A UNIFIED MEMORY ARCHITECTURE (UMA)

(71) Applicant: SANDISK TECHNOLOGIES INC., PLANO, TX (US)

(72) Inventors: TAL ROSTOKER, KFAR VRADIM (IL); ALON MARCU, TEL-MOND (IL); ROTEM SELA, HAIFA (IL)

(73) Assignee: SANDISK TECHNOLOGIES INC.

(21) Appl. No.: 14/330,552

(22) Filed: Jul. 14, 2014

(51) Int. Cl. G06F 3/06

(52) U.S. Cl. CPC G06F 3/0611; G06F 3/0653; G06F 3/0659; G06F 3/0685

(57) ABSTRACT

A method includes, in a data storage device including a non-volatile memory, receiving, from a host device, a read command to read data from the non-volatile memory. The host device is coupled to the data storage device and includes a memory having a unified memory (UM) area. The method also includes, responsive to the read command, sending a UM read command to the host device. The UM read command instructs the host device to read the data from a location of the UM area.

### FIELD OF THE DISCLOSURE

The present disclosure is generally related to enabling access to a host memory associated with a unified memory architecture (UMA).

### BACKGROUND

Non-volatile data storage devices, such as embedded memory devices (e.g., embedded MultiMedia Card (eMMC) devices) and removable memory devices (e.g., removable universal serial bus (USB) flash memory devices and other removable storage cards), have allowed for increased portability of data and software applications. Users of non-volatile data storage devices increasingly rely on the non-volatile storage devices to store and provide rapid access to a large amount of data.

In some architectures, such as a unified memory architecture (UMS), a data storage device (e.g., a non-volatile data storage device) may be able to utilize at least a portion of a host random access memory (RAM) to store data storage device data, such as cache data or table tracking data used by the data storage device, and/or to store host data received from the host device to be stored at a non-volatile memory of the data storage device. In such architectures, when the data storage device receives, from the host device, a read request associated with the host data stored at the host RAM, multiple operations are performed to enable the data storage device to receive the host data from the host RAM, to temporarily store the host data at RAM in the data storage device, and to provide the host data from the RAM in the data storage device to the host device to complete execution of the read request. The multiple operations cause unnecessary latency between the host device sending the read request and the host device receiving the data corresponding to the read request from the data storage device.

### SUMMARY

Techniques are disclosed to enable access to a host memory associated with a unified memory architecture (UMA). A host device that includes the host memory, such as a host random access memory (RAM), associated with a unified memory architecture (UMA) may be coupled to a data storage device. The data storage device may direct (e.g., control) access to a unified memory (UM) area of the host memory. For example, the data storage device may store data at the UM area of the host memory. The data may include predicted data, such as read ahead data or pre-fetched data that is stored at a memory (e.g., a non-volatile memory) of the data storage device. Based on a read request received from the host device to read the data from the memory of the data storage device, the data storage device may send a UM read command to the host device. The UM read command may instruct the host device to directly access the data from the UM area of the host device. Responsive to the host device accessing the data from the UM area, the host device may send an acknowledge message to the data storage device indicating that the host read the data from the UM area. Based on the acknowledge message, the data storage device may indicate that the location of the UM area that stored the data is available to store new data. The UM read command and/or the acknowledge message may be associated with and/or defined by one or more universal flash storage (UFS) protocols.

By instructing the host device to read the data directly from the host RAM, the data storage device may avoid performing multiple operations to provide the data to the host device responsive to the read request. Accordingly, the UM read command may reduce latency and reduce delay between the host device sending the read request and the host device receiving the data corresponding to the read request. Additionally, by receiving the acknowledgment message from the host device after the host device reads the data from the host RAM, the data storage device may determine that it is no longer necessary to maintain (e.g., keep) the data stored at the UM area. Accordingly, the data storage device may identify a location of the UM area that stores the data as available to store new data. Thus, the acknowledge message may enable the data storage device to track use by the host device of the UM area and to maintain an available storage space (e.g., available storage locations) at the UM area.

### BRIEF DESCRIPTION OF THE DRAWINGS

FIG. 1 is a block diagram of a particular illustrative embodiment of a system that enables access to a host memory of a unified memory architecture (UMA);

FIG. 2 is a ladder diagram illustrating operations to enable access to a host memory of a unified memory architecture (UMA);

FIG. 3 is a flow diagram of an illustrative embodiment of a method to enable access to a unified memory (UM) area;

FIG. 4 is a flow diagram of an illustrative embodiment of a method to enable acknowledgement of data accessed from a unified memory (UM) area;

FIG. 5 is a flow diagram of an illustrative embodiment of a method to enable access to a unified memory (UM) area; and

FIG. 6 is a flow diagram of an illustrative embodiment of a method to enable acknowledgement of data accessed from a unified memory (UM) area.

### DETAILED DESCRIPTION

Particular embodiments of the present disclosure are described with reference to the drawings. In the description, common features are designated by common reference numbers throughout the drawings.

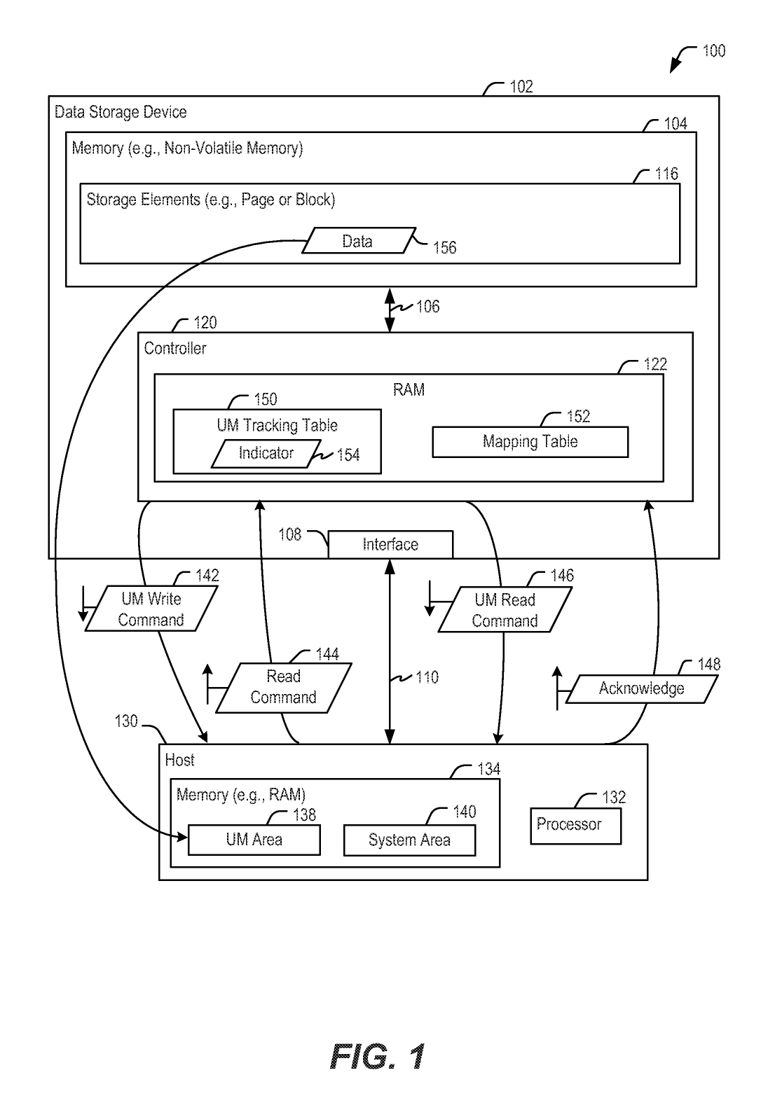

FIG. 1 is a block diagram of a particular illustrative embodiment of a system 100 including a data storage device 102 and a host device 130. The system 100 may be configured to enable the data storage device 102 to direct (e.g., control) access to a unified memory (UM) area 138 of a memory 134 of the host device 130. For example, the system 100 may enable the data storage device 102 to track data stored at the UM area 138 and to instruct the host device 130 to read the data directly from the UM area 138 based on a read request received at the data storage device 102 from the host device 130.

The data storage device 102 may be embedded within the host device 130, such as in accordance with an embedded MultiMedia Card (eMMC®) (trademark of Joint Electron Devices Engineering Council (JEDEC) Solid State Technology Association, Arlington, Va.) configuration. Alternatively, the data storage device 102 may be removable from (i.e., “removably” coupled to) the host device 130. For example, the data storage device 102 may be removably coupled to the host device 130 in accordance with a removable universal serial bus (USB) configuration. In some embodiments, the data storage device 102 may include or correspond to a solid state drive (SSD), which may be used as an embedded storage drive, an enterprise storage drive (ESD), or a cloud storage drive (CSD), as illustrative, non-limiting examples.

The host device 130 may include a processor 132 and a memory 134. The memory 134, such as a random access memory (RAM), may include the unified memory (UM) area 138 (e.g., a UM portion) and a system area 140 (e.g., a system portion). The system area 140 may be controlled and/or utilized by the host device 130. For example, the system area 140 may be available (e.g., utilized) by the processor 132 and/or an operating system (OS) of the host device 130. The UM area 138 may be associated with a unified memory architecture (UMA) and may be designated for use by the data storage device 102. For example, the UM area 138 may be controlled by the data storage device 102 and the host device 130 may be configured to access (e.g., read to or write from) the UM area 138 at the direction (e.g., instruction) of the data storage device 102. To illustrate, the UM area 138 may logically belong to the data storage 102 as if the UM area 138 were a physical memory (e.g., a RAM) of the data storage device 102 and the data storage device 102 may use the UM area 138 as a working memory (e.g., a level two physical table cache, a write buffer, etc.) of the data storage device 102.

The data storage device 102 may be coupled to the host device 130 via a communication path 110, such as a wired communication path and/or a wireless communication path. For example, the data storage device 102 may include an interface 108 (e.g., a host interface) that enables communication (via the communication path 110) between the data storage device 102 and the host device 130, such as when the interface 108 is coupled to the host device 130. The host device 130 and the data storage device 102 may communicate with each other (via the communication path 110) using a protocol, such as a universal flash storage (UFS) protocol. For example, the host device 130 and the data storage device 102 may communicate commands and/or messages defined by and/or corresponding to one or more Joint Electron Devices Engineering Council (JEDEC®) (trademark of Joint Electron Devices Engineering Council (JEDEC) Solid State Technology Association, Arlington, Va.) standards. The one or more JEDEC standards may include or correspond to one or more universal flash storage (UFS) standards, such as JESDA223A UFS Host Controller Interface (HCl) standard, JESD220-1 UFS Unified Memory Extension standard, JESD223B UFS Host Controller Interface (UFSHCI) standard, JESD223-1 UFS Host Controller Interface (UFSHCI), and/or Unified Memory Extension standard, JESD224 UFS (Test) standard, as illustrative, non-limiting examples.

The data storage device 102 may include a memory 104 coupled to a controller 120. The memory 104, such as a non-volatile memory (e.g., a flash memory), may be coupled to the controller 120 via a bus 106, an interface, another structure, or a combination thereof. The memory 104 may have a three dimensional (3D) memory configuration. Alternatively, the memory 104 may have another memory configuration, such as a two dimensional (2D) memory configuration. The memory 104 may include a plurality of storage elements 116 configured to store data, such as the data 156. The plurality of storage elements 116 may be configured in one or more pages, wordlines, and/or blocks. The plurality of storage elements 116 may be included in a single die or in multiple dies. Although not illustrated in FIG. 1, the memory 104 may include read/write circuitry configured to read data from or write data to storage elements of the memory 104, such as memory cells in the plurality of storage elements 116.

The controller 120 may be configured to issue one or more commands (and/or messages) to the host device 130. Each of the one or more commands (and/or messages) issued to the host device 130 by the data storage device 102 (e.g., the controller 120) may be associated with and/or defined by a protocol, such as a UFS protocol, used for communication between data storage device 102 and the host device 130. For example, a format of each of the one or more commands may be associated with and/or defined by the protocol. The one or more commands may include an “access UM area” command, a “DATA IN universal flash storage (UFS) protocol information unit (UPIU)” command, a “UM write” command 142, a “UM read” command 146 (e.g., a “‘virtual’ DATA IN UPIU” command), a “response” message, or a combination thereof, as illustrative, non-limiting examples.

The access UM area command may instruct the host device 130 to read data stored at the UM area 138 and to provide (e.g., send) the data to the data storage device 102. For example, the access UM area command may include a pointer (e.g., a UM address) associated with a location of the UM area 138, an amount (e.g., a size) of data to be read, or a combination thereof. The access UM area command may be issued by the data storage device 102 to retrieve data, such as cache data or table tracking data (e.g., mapping table data associated with a mapping table 152), from the UM area 138 that is to be processed by the controller 120.

The data storage device 102 may send the DATA IN UPIU command to provide the host device 130 with data read from the memory 104 of the data storage device 102. For example, the data storage device 102 may send the DATA IN UPIU based on a read request received from the host device 130, such as a read command 144 received from the host device 130, as described further herein.

The UM write command 142 may instruct the host device 130 to write data, such as the data 156, cache data, and/or tracking data, to the UM area 138 of the memory 134 of the host device 130. The UM write command 142 may include the data, such as the data 156, to be written to the UM area 138, an indication of a location (e.g., a UM address) of the UM area 138, or a combination thereof.

In some embodiments, the data storage device 102 may send the UM write command 142 based on identification of predicted data, such as data stored at the memory 104 that is likely (e.g., probable) to be requested by the host device 130. The controller 120 may identify the predicted data responsive to a “read ahead” command (e.g., a “pre-fetch” command) received from the host device 130 that indicates a logical address or a location of the memory 104 where the predicted data is stored. Alternatively or additionally, the controller 120 may identify the predicted data based on tracking read requests received from the host device 130 and determining (e.g., identifying) a pattern or sequence of the read requests. For example, the controller 120 may identify a particular sequence of read requests in which a first read request (e.g., to read a first logical address or a first location of the memory 104) is followed by a second read request (e.g., to read a second logical address or a second location of the memory 104). Accordingly, when the data storage device 102 receives the first read request of the particular sequence of read requests, the controller 120 may identify the data stored at the second location of the memory as predicted data. The controller 120 may generate a particular UM write command that includes the data from the second location and may send the particular UM write command to the host device 130 prior to receiving the second read request of the particular sequence of read requests.

The data storage device 102 may send the UM read command 146 (e.g., the “‘virtual’ DATA IN UPIU” command) to the host device 130 to enable the host device 130 to read data, such as the data 156, from the UM area 138 of the memory 134. For example, the data storage device 102 may send the UM read command 146 to the host device 130 based on a read request (e.g., such as the read command 144) received from the host device 130. To illustrate, when the read request is associated with data stored at the memory 104 that the controller 120 identified as predicted data and stored to the UM area 138, the controller 120 may send the UM read command 146 to enable the host device 130 to directly access the data (e.g., the predicted data) from the UM area 138. The UM read command 146 may include a pointer that indicates a location (e.g., a UM address) of the UM area 138, the UM address of the UM area 138, an amount (e.g., a size) of data to be read from the UM area 138, or a combination thereof. The UM read command 146 may also enable the host device 130 to process the data read from the UM area 138 without sending the data read from the UM area 138 to the data storage device 102 prior to processing the data.

The data storage device 102 may send the response message to the host device 130 to indicate a completion of a read request (e.g., the read command 144) received from the host device 130. For example, based on a particular read request received from the host device 130, the data storage device 102 may send one or more UM read commands, one or more DATA IN UPIU commands, or a combination thereof, to satisfy the particular read request. After the data storage device 102 completes (e.g. satisfies) the particular read request, the data storage device 102 (e.g., the controller 120) may send the response message that indicates the data storage device 102 completed execution of the particular read request.

The controller 120 may include a random access memory (RAM) 122. The RAM 122, such as a volatile memory, may be configured to store a unified memory (UM) tracking table 150, a mapping table 152, or a combination thereof. The mapping table 152 may include a logical to physical mapping table. For example, the controller 120 may use the mapping table 152 to map one or more logical addresses (e.g., a range of logical block address) received from the host device 130 to one or more physical addresses that correspond to storage locations of the memory 104. The controller 120 may update the mapping table 152 as data is written to and/or erased from the memory 104.

The UM tracking table 150 may be configured to track data stored at one or more storage locations (e.g., UM addresses) of the UM area 138 of the memory 134 of the host device 130. The controller 120 may update the UM tracking table 150 to reflect the data stored at UM area 138. To illustrate, when the controller 120 stores the data 156 at the UM area 138 of the memory 134, the controller 120 may generate an indicator 154. The indicator 154 may be included in or correspond to an entry in the UM tracking table 150. The indicator 154 may include a logical address that corresponds to the data 156 stored at the memory 104, a physical address that correspond to the data 156 stored at the memory 104, a UM address that corresponds to the data 156 stored at the UM area 138 of the memory 134, an amount of the data 156 stored at the UM area 138, or a combination thereof, as illustrative, non-limiting examples.

As another example, the controller 120 may store first data at storage elements corresponding to a first UM address of the UM area 138. Accordingly, the controller 120 may update the UM tracking table 150 to include a first indicator that indicates that the first data is stored at the first UM address. As another example, the controller 120 may store second data at storage elements corresponding to a second UM address of the UM area 138. Accordingly, the controller 120 may update the UM tracking table 150 to include a second indicator that indicates that the second data is stored at the second UM address.

The controller 120 may be configured to receive data and commands (e.g., instructions) from the host device 130 and may access the memory 104 based on the received commands. The controller 120 may send one or more write requests to the memory 104 to store the data to a specified address of the memory 104. The write request may specify a physical address of a portion of the memory 104 (e.g., a physical address of a word line of the memory 104) that is to store the data. The controller 120 may be configured to send a read request to the memory 104 to access data from a specified address of the memory 104. To illustrate, the controller 120 may send a read request to access the data stored in the memory 104. The read request may specify the physical address of a portion of the memory 104 (e.g., a physical address of a word line storing the data).

The controller 120 may be configured to receive one or more commands (and/or messages) from the host device 130. Each of the one or more commands (and/or messages) received at the data storage device 102 from the host device 130 may be associated with and/or defined by the protocol, such as the UFS protocol, used for communication between data storage device 102 and the host device 130. For example, a format of each of the one or more commands may be associated with and/or defined by the protocol. The one or more commands sent by the host device 130 and received by the data storage device 102 (e.g., the controller 120) may include a “write” command (e.g., a write request), a “read ahead” command (e.g., a “pre-fetch” command), a “read” command 144 (e.g., the read request), a “UM data out” command, an “acknowledge” message 148, or a combination thereof, as illustrative, non-limiting examples.

The write command (e.g., a write instruction) may instruct the controller 120 to write data to a location of the memory 104. For example, the write command received from the host device 130 may include a small computer system interface (SCSI) write command. To illustrate, a particular write command may instruct the controller 120 to store the data 156 at a location of the memory 104.

The read ahead command (e.g., the pre-fetch command) may indicate that host device 130 intends to request particular data, such as the data 156, from the data storage device 102. For example, the read ahead command may indicate one or more logical block addresses, an amount of data to be read, or a combination thereof. Based on the read ahead command, the controller 120 may identify data associated with the read ahead command as predicted data and may send the UM write command 142 to cause the host device 130 to store the predicted data at the UM area 138.

The read command 144 (e.g., a read instruction) may instruct the controller 120 to read data from a location of the memory 104. For example, the read command 144 received from the host device 130 may include a small computer system interface (SCSI) read command. To illustrate, the read command 144 may instruct the data storage device 204 to read the data 156 from the memory 104. The read command 144 may include (e.g. identify) one or more logical addresses (e.g., a range of logical block address), an amount (e.g., size) of data to read, or a combination thereof.

The UM data out command may provide the data storage device 102 with data (e.g., mapping table data) read from the UM area 138 of the memory 134 of the host device 130. The UM data out command may be responsive to and/or correspond to the access UM area command sent by the data storage device 102.

An acknowledge message 148 (e.g., the acknowledgement command) may indicate that the host device 130 read data from a location the UM area 138 based on the UM read command 146 (e.g., the “‘virtual’ DATA IN UPIU” command) issued by the data storage device 102. The acknowledge message 148, when received by the controller 120, may indicate that the location (e.g., a UM address) of the UM area 138 is available, such that the controller 120 may store different data at the location.

During operation, the data storage device 102 may receive a write command from the host device 130 to write the data 156 to a location (e.g. a storage location) of the memory 104. After storing the data 156 at the memory 104, the controller 120 may update the mapping table 152 based on the location of the data 156 in the memory 104.

After storing the data 156 at the memory 104, the controller 120 may identify the data 156 as predicted data, such as read ahead data or pre-fetch data. Based on identification of the data 156 as the predicted data, the controller 120 may send the UM write command 142 to the host device 130. The UM write command 142 may instruct the host device 130 to write the data 156 to the UM area 138 of the memory 134 (e.g., a host RAM). In addition to sending the UM write command 142 to the host device 130, the controller 120 may generate the indicator 154 and may store the indicator 154 in the UM tracking table 150. The indicator 154 may indicate a location of the UM area 138 where the data 156 is stored.

After sending the UM write command 142 to the host device 130, the data storage device 102 may receive the read command 144 (e.g., a read request) from the host device 130 to read the data 156 from the memory 104, such as when the prediction by the controller 120 (that the data 156 is to be accessed) is correct. For example, the read command 144 may include a logical address associated with the data 156 in the memory 104 to be read by the data storage device 102. The controller 120 may use the mapping table 152 to identify a physical address of the data 156 based on the logical address indicated by the read command 144. Based on the physical address and/or the logical address, the controller 120 may use the UM tracking table 150 to determine whether the data 156 is stored at the UM area 138 of the host device 130. Based on a determination that the data 156 is stored at the UM area 138, the controller 120 may determine a location (e.g., a UM address associated with the data 156) of the data 156 in the UM area 138 and may send the UM read command 146 to the host device 130.

After sending the UM read command 146, the data storage device 102 may receive the acknowledge message 148 from the host device 130. The acknowledge message 148 may indicate to the data storage device 102 that the host device 130 accessed (e.g., read) the data 156 from the UM area 138. Responsive to the acknowledge message 148, the controller 120 may update the UM tracking table 150 to indicate that the location (e.g., the UM address) of the UM area 138 corresponding to the data 156 is available to store different data (e.g., the data 156 is no longer predicted to be requested and so may no longer be maintained at the UM area 138).

In some embodiments, the data storage device 102 may not receive the acknowledge message 148 from the host device 130. For example, the host device 130 may not be configured to send the acknowledge message 148 after accessing the data 156 from the UM area 138. In such embodiments, the data storage device 102 may assume that the host device 130 accessed the data 156 in response to the UM read command 146. Accordingly, after sending the UM read command 146, the controller 120 may update the UM tracking table 150 to indicate that the UM address corresponding to the data 156 is available to store new data. To illustrate, the controller 120 may wait for a predetermined time period after sending the UM read command 146 before indicating that the UM address is available.

In some embodiments, the controller 120 may maintain particular data (e.g., predicted data) at the UM area 138 based on a threshold. For example, the threshold may be a threshold amount of time (e.g., a number of clock cycles) or a threshold number of operations or request (associated with access to the memory 104). The threshold amount of time may be a total amount of time that the particular data is stored at the UM area 138. The controller 120 may maintain the particular data at the UM area 138 based on tracking data included in the UM tracking table 150. To illustrate, a particular UM address indicated by the UM tracking table 150 as storing predicted data may be changed to an available status (to store new data) when the threshold is satisfied (e.g., when an amount of time that the particular data is stored at the UM area 138 is equal to or exceeds the threshold amount of time). For example, when the threshold is satisfied, the controller 120 may update the UM tracking table 150 to indicate that the particular UM address is available to store new data (e.g., different data). As another example, the controller 120 may remove an entry of the UM tracking table 150 that corresponds to the UM address when the threshold is satisfied.

Although the host device 130 is illustrated as including a single memory (e.g., the memory 134), the host device 130 may include one or more additional memories. The memory 134 and/or the one or more additional memories may be configured to store data and/or instructions that may be executable by the processor 132. Additionally, the memory 134 may be a single memory or may include one or more memories, such as one or more non-volatile memories, one or more volatile memories, or a combination thereof.

Although the UM tracking table 150 and the mapping table 152 are illustrated as separate tables, in other embodiments the UM tracking table 150 and the mapping table 152 may be combined into a single table. For example, a particular entry of the mapping table 152 that maps a particular logical address to a particular physical address of the memory 104 may also identify a particular UM address of the UM area 138 when particular data stored at the particular physical address is to be stored (or is stored) at the particular UM address. To illustrate, the controller 120 may generate a particular indicator, such as the indicator 154, corresponding to the particular data being stored at the particular UM address and may update the particular entry to include the particular indicator. The particular indicator may identify the particular UM address of the UM area 138 of the memory 134. Accordingly, when the data storage device 102 receives a read request (e.g., a Read Command) from the host device 130 that identifies the particular logical address, the data storage device 102 may access the particular entry of the mapping table 152 and, based on the particular indicator, identify the particular UM address of the UM area 138.

Additionally or alternatively, although the UM tracking table 150 and the mapping table 152 are illustrated as being stored at the RAM 122 included in the controller 120, in other implementations the UM tracking table 150 and/or the mapping table 152 may be stored at the memory 104, at the memory 134 (e.g., the UM area 138), at another memory that is coupled to the controller 120, or a combination thereof. Additionally or alternatively, the controller 120 may include a single memory component, such as the RAM 122 or may include multiple distinct memory components and/or multiple different types of memory components.

Additionally, the data storage device 102 may include an error correction code (ECC) engine (not shown). The ECC engine may be configured to receive data, such as the data 156, and to generate one or more error correction code (ECC) codewords (e.g., including a data portion and a parity portion) based on the data. For example, the ECC engine may include an encoder configured to encode the data using an ECC encoding technique. The ECC engine may include a Reed-Solomon encoder, a Bose-Chaudhuri-Hocquenghem (BCH) encoder, a low-density parity check (LDPC) encoder, a turbo encoder, an encoder configured to encode the data according to one or more other ECC techniques, or a combination thereof, as illustrative, non-limiting examples.

The ECC engine may include a decoder configured to decode data read from the memory 104 to detect and correct bit errors that may be present in the data. For example, the ECC engine may correct a number of bit errors up to an error correction capability of an ECC technique used by the ECC engine. A number of errors identified by the ECC engine may be tracked by the controller 120, such as by the ECC engine. For example, based on the number of errors, the ECC engine may determine a bit error rate (BER) associated with one or more blocks of the memory 104.

By enabling the data storage device 102 to instruct the host device 130 to read the data directly from the UM area 138 (e.g., the host RAM), the data storage device 102 may advantageously store data, such as predicted data (e.g., read ahead data or pre-fetched data) at the UM area 138. Storing the data (e.g., predicted data) at the UM area 138 may enable the data storage device 102 to quickly provide the data to the host device 130 responsive to the read command 144 that requests the data. For example, the data storage device 102 may avoid having multiple operations to provide the data to the host device 130, which may reduce latency and reduce delay associated with providing the data to the host device 130. Additionally, by receiving the acknowledge message 148 from the host device 130, the data storage device 102 may determine that it is no longer necessary to keep the data at the UM area 138. Accordingly, the data storage device 102 may update the UM tracking table 150 based on the acknowledge message 148 and may maintain (e.g., track) available storage space (e.g., available storage locations) at the UM area 138.

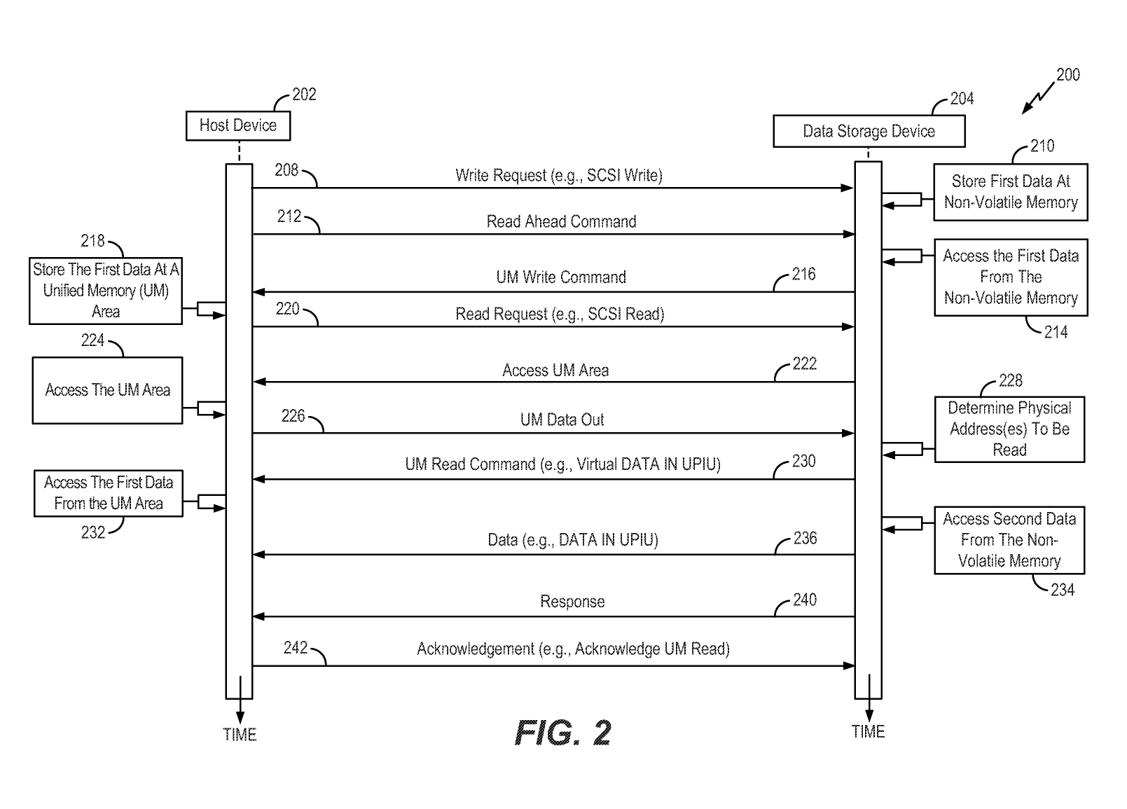

Referring to FIG. 2, a first illustrative embodiment of a method 200 of communicating between a representative host device 202 and a representative data storage device 204 is shown. The method 200 is illustrated by a ladder diagram. The method 200 may be used to enable access to a host memory associated with a unified memory architecture (UMA). For example, the host device 202 and the data storage device 204 may include or correspond to the host device 130 and the data storage device 102 of FIG. 1, respectively. The host device 202 and the data storage device 204 may be configured to communicate using a protocol, such as a universal flash storage (UFS) protocol defined by one or more JEDEC standards. The one or more JEDEC standards may include or correspond to one or more Universal Flash Storage (UFS) standards, such as JESDA223A UFS Host Controller Interface (HCl) standard, JESD220-1 UFS Unified Memory Extension standard, JESD223B UFS Host Controller Interface (UFSHCI) standard, JESD223-1 UFS Host Controller Interface (UFSHCI), and/or Unified Memory Extension standard, JESD224 UFS (Test) standard, as illustrative, non-limiting examples.

The host device 202 may send, to the data storage device 204, a write request (e.g., a write command) that instructs the data storage device 204 to write first data to a non-volatile memory of the data storage device 204, at 208. The write request may include the first data, such as the data 156 of FIG. 1. The write request may be a small computer system interface (SCSI) write command. The non-volatile memory of the data storage device 204 may include or correspond to the memory 104 of FIG. 1.

Based on the write request, the data storage device 204 may store the first data at the non-volatile memory of the data storage device 204, at 210. For example, the data storage device 204 may store the first data at a location corresponding to a first address (e.g., a first physical address) of the non-volatile memory. The data storage device 204 may update a mapping table, such as a logical to physical mapping table, based on the first address. For example, the mapping table may include or correspond to the mapping table 152 of FIG. 1. The mapping table may be stored at the non-volatile memory of the data storage device 204, at a random access memory (RAM) of the data storage device 204, such as the RAM 122 of FIG. 1, at a memory (e.g., a RAM) of the host device 202, such as the memory 134 of FIG. 1, or a combination thereof.

The host device 202 may send a read ahead command to the data storage device 204, at 212. The read ahead command (and/or a pre-fetch command) may indicate that host device 202 intends to request the first data from the data storage device 204. For example, the read ahead command may indicate one or more logical block addresses, an amount of data that may be read, or a combination thereof. Based on the read ahead command, the data storage device 204 may determine that the host device 202 may (e.g., is likely to) send a read request associated with the first data.

Based on the read ahead command, the data storage device 204 may identify the first data as predicted data and may access (e.g., read) the first data from the non-volatile memory, at 214. For example, the data storage device 204 may read the first data from the location (corresponding to the first physical address) of the non-volatile memory.

The data storage device 204 may send a unified memory (UM) write command to the host device 202, at 216. The UM write command, such as the UM write command 142 of FIG. 1, sent by the data storage device 204 may instruct the host device 202 to write the first data to a unified memory (UM) area of a memory of the host device 202. The UM area of the memory of the host device 202 may include or correspond to the UM area 138 of the host device 130 of FIG. 1. The data storage device 204 may access a UM tracking table, such as the UM tracking table 150 of FIG. 1, to identify an available location of the UM area of the memory of the host device 202. For example, after accessing the first data from the non-volatile memory, the data storage device 204 may identify the available location (e.g., a UM address) of the UM area of the memory of the host device 202. The UM write command may include the first data read from the non-volatile memory, an indication (e.g., a UM address) associated with the available location, or a combination thereof. After sending the UM write command, the data storage device 204 may update the UM tracking table to reflect the first data being stored at the available location of the UM area of the memory of the host device 202.

The host device 202 may store the first data at the UM area of the memory of the host device 202, at 218. For example, the host device 202 may store the first data at a location of the UM area that corresponds to the UM address responsive to the UM write command.

The host device 202 may send a read request (e.g., a read command) to the data storage device 204, at 220. For example, the read request may include or correspond to the read command 144 of FIG. 1. The read request may be a small computer system interface (SCSI) read command. The read command may instruct the data storage device 204 to read at least the first data from the non-volatile memory of the data storage device 204. For example, the read request may include (e.g. identify) one or more logical addresses (e.g., a range of logical block address), an amount of data to read, or a combination thereof.

Based on the read request that identifies the one or more logical addresses, the data storage device 204 may determine one or more physical addresses of the non-volatile memory of the data storage device 204 to be read. For example, the data storage device 204 may determine the one or more physical addresses using the mapping table. The data storage device 204 may store the mapping table at the data storage device 204 and may use the mapping table to identify the one or more physical addresses of the non-volatile memory of the data storage device 204. In the event that a portion of the mapping table corresponding to the first data is stored in the UM area, the data storage device 204 may send an access UM area command to the host device 202, at 222. Prior to sending the access UM area command, the data storage device 204 may use the UM tracking table to determine (e.g., identify) a portion of the UM area that includes at least the portion of the mapping table desired by the data storage device 204. The access UM area command may instruct the host device 202 to access a portion of the UM area that stores the mapping table.

Based on the access UM area command, the host device 202 may access the portion of the UM area of the host device 202, at 224, and may send a UM data out command to the data storage device 204, at 226. The UM data out command may provide the data storage device 204 with particular data (e.g., mapping table data) read from the UM area responsive to the access UM area command.

The data storage device 204 may determine, based on the particular data (e.g., the mapping table data) included in the UM data out command, one or more physical addresses to be read responsive to the read request received from the host device 202, at 228. For each of the one or more physical addresses, the data storage device 204 may determine whether the physical address is associated with data stored at the host device 202. For example, the data storage device 204 may use the UM tracking table to determine whether data corresponding to a particular physical address of the non-volatile memory of the data storage device 204 is stored at the UM area of the memory of the host device 202. To illustrate, the one or more physical addresses may include the first physical address and a second physical address. Based on the first physical address and the UM tracking table, the data storage device 204 may determine that the first data is stored at the UM area of the host device 202 and may identify the UM address of the UM area where the first data is stored. Based on the second physical address and the UM tracking table, the data storage device 204 may determine that second data (corresponding to the second physical address) is not stored at the UM area of the host device 202. Although the one or more physical addresses is described as including two physical addresses, in other embodiments the one or more physical addresses may include a single physical address or more than two physical addresses.

Based on the first physical address, the data storage device 204 may send a UM read command to the host device 202, at 230. The UM read command may include or correspond to the UM read command 146 of FIG. 1. The UM read command may enable the host device 202 to read, based on the UM address, the first data from the UM area. For example, the UM read command may include the UM address of the UM area, a pointer that indicates the UM address of the UM area, an amount (e.g., a size) of data to be read from the UM area, or a combination thereof. The UM read command may also enable the host device 202 to process the first data without sending the first data read from the UM area to the data storage device 204 prior to processing the first data. The UM read command may include or correspond to a “virtual” data in universal flash storage (UFS) protocol information unit (UPIU) command.

Based on the UM read command, the host device 202 may read the first data from the UM area of the memory of the host device 202, at 232. For example, the host device 202 may identify the pointer included in the UM read command that indicates the location of the UM area, a size of the data to be read from the UM area, or a combination thereof. The host device 202 may read the UM address of the UM area and may provide the first data read from the UM area to a processor of the host device 202, such as the processor 132 of the host device 130 of FIG. 1.

Based on the second physical address, the data storage device 204 may access (e.g., read the second data from) the second physical address of the non-volatile memory of the data storage device 204, at 234. The data storage device 204 may transfer data (e.g., the second data) to the host device 202, at 236. For example, the data storage device 204 may transfer (e.g., send) the second data to the host device 202 using a DATA IN UPIU command.

The data storage device 204 may send a response to the host device 202, at 240. The response may indicate that the data storage device 204 completed execution of the read request.

The host device 202 may send an acknowledgement message to the data storage device 204, at 242. The acknowledgement message may indicate that the host device 202 read the first data and that the UM address (e.g., a location) of the UM area as available. The acknowledgment message (e.g., an acknowledge UM read message) may include or correspond to the acknowledge message 148 of FIG. 1. The acknowledgement message may be responsive to the UM read command (associated with the first data) sent from the data storage device 204 to the host device 202.

Although the data storage device 204 is described as accessing the data, at 214, responsive to the read ahead command received from the host device 202, in other embodiments the data storage device 204 may access the data without receiving the read ahead command. For example, data storage device 204 may use a pattern and/or a sequence of the read requests to identify the data as predicted data and may access the data based on a determination that the data is predicted data.

Although the data storage device 204 is described as having to send the access UM area command, at 222, to receive the particular data (e.g., mapping table data), in other embodiments, the particular data (e.g., the mapping table data) may be stored at the data storage device 204. Accordingly, the data storage device 204 may not have to send the access UM area command to the host device 202 to enable the determine the one or more physical addresses to be read responsive to the read request received from the host device 202.

By communicating the UM read command (e.g., the “virtual” data in UFSUPIU command) from the data storage device 204 to the host device 202, the host device 202 may be enabled to (directly) access the first data stored at the UM area of the host device 202. Additionally, by communicating the acknowledgement message from the host device 202 to the data storage device 204, the data storage device 204 may verify that the host device 202 received the first data and may determine that the first data stored at the UM area in no longer needed and can be replaced (e.g., overwritten).

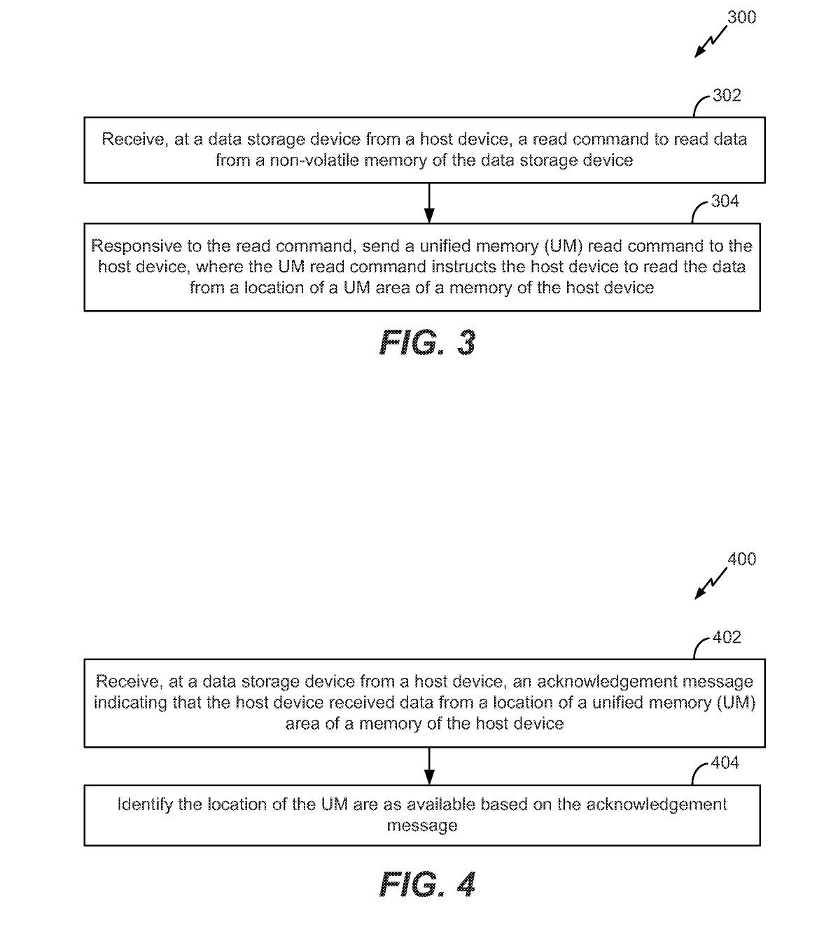

Referring to FIG. 3, an illustrative embodiment of a method 300 to enable access to a unified memory (UM) area is shown. For example, the method 300 may be performed by a controller of the data storage device, such as by the controller 120 of the data storage device 102 of FIG. 1 or a controller of the data storage device 204 of FIG. 2.

The method 300 includes receiving, at the data storage device from a host device, a read command to read data from a non-volatile memory of the data storage device, at 302. For example, the read command may include or correspond to the read command 144 of FIG. 1. The read command may include a small computer system interface (SCSI) read command. The read command may include a logical address that corresponds to a physical address of the non-volatile memory that stores the data. The data stored in the non-volatile memory may include or correspond to the data 156 of the non-volatile memory 104 of FIG. 1.

The host device and the data storage device may be configured to communicate using a universal flash storage (UFS) protocol, such as a UFS protocol defined by one or more JEDEC standards. The host device may include or correspond to the host device 130 of FIG. 1 or the host device 202 of FIG. 2.

The method 300 also includes sending a unified memory (UM) read command to the host device responsive to the read command, where the UM read command instructs the host device to read the data from a location of a UM area of a memory of the host device, at 304. The UM area of the memory of the host device may include or correspond to the UM area 138 of the memory 134 of FIG. 1. The UM read command may include a pointer that indicates the UM address of the UM area, the UM address of the UM area, an amount (e.g., a size) of data to be read from the UM area, or a combination thereof. The UM read command, such as the UM read command 142 of FIG. 1, may enable the host device to directly access the data from the UM area of the memory of the host device. For example, the UM read command may enable the host device to read the data from the location of the UM area and to process the data without sending the data read from the location of the UM area to the data storage device prior to processing the data. The UM read command may include or correspond to a “virtual” data in universal flash storage (UFS) protocol information unit (UPIU) command A format of the UM read command may be defined by one or more JEDEC standards.

The method 300 may enable the host device to (directly) access the data stored at the UM area of the host device. Accordingly, the data storage device may store the data, such as predicted data (e.g., read ahead data or pre-fetch data) at the UM area of the host device without increasing a latency associated with providing the data to the host device responsive to the read request. Additionally, by storing the data at the UM area and not at a random access memory (RAM) of the data storage device, the data storage device may have more storage space available at the RAM of the data storage device than if the data (e.g., the predicted data) were stored at the RAM of the data storage device.

Referring to FIG. 4, an illustrative embodiment of a method 400 to enable acknowledgement of data accessed from a unified memory (UM) area is shown. For example, the method 400 may be performed by a controller of the data storage device, such as by the controller 120 of the data storage device 102 of FIG. 1 or a controller of the data storage device 204 of FIG. 2.

The method 400 includes receiving, at the data storage device from a host device, an acknowledgement message indicating that the host device received data from a location of a unified memory (UM) area of a memory of the host device, at 402. The location may correspond to an address (e.g., a UM address) of the UM area. The acknowledgment message (e.g., an acknowledge UM read message) may include or correspond to the acknowledge message 148 of FIG. 1. The UM area of the memory of the host device may include or correspond to the UM area 138 of the memory 134 of the host device 130 of FIG. 1. The host device and the data storage device may be configured to communicate using a universal flash storage (UFS) protocol, such as a UFS protocol defined by one or more JEDEC standards. A format of the acknowledgement message may be defined by one or more JEDEC standards.

The method 400 further includes identifying the location of the UM area as available based on the acknowledgement message, at 404. The data storage device may identify the location of the UM area as available by updating a tracking table maintained by the data storage device. The UM tracking table may be used to track storage locations associated with the UM area. For example, the data storage device may maintain one or more tracking tables, such as a UM tracking table 150 and/or a mapping table 152 of FIG. 1, that enable the data storage device to track memory locations of the UM area of the host device. Based on the acknowledgment message, the data storage device may determine that the host device read the data from the location of the UM area and may update the tracking table to indicate that new data (e.g., different data) may be stored at the location of the UM area.

The method 400 may enable the data storage device to update a UM tracking table based on the acknowledgement message. Accordingly, based on the acknowledgement message, the data storage device may be informed that the host device received the data (e.g., predicted data) from the UM area and may determine that the data stored at the UM area may be overwritten (e.g., the data is no longer needed to be stored at the UM area). Additionally, based on the acknowledgement message, the data storage device may track available storage space (e.g., available storage locations) at the UM area.

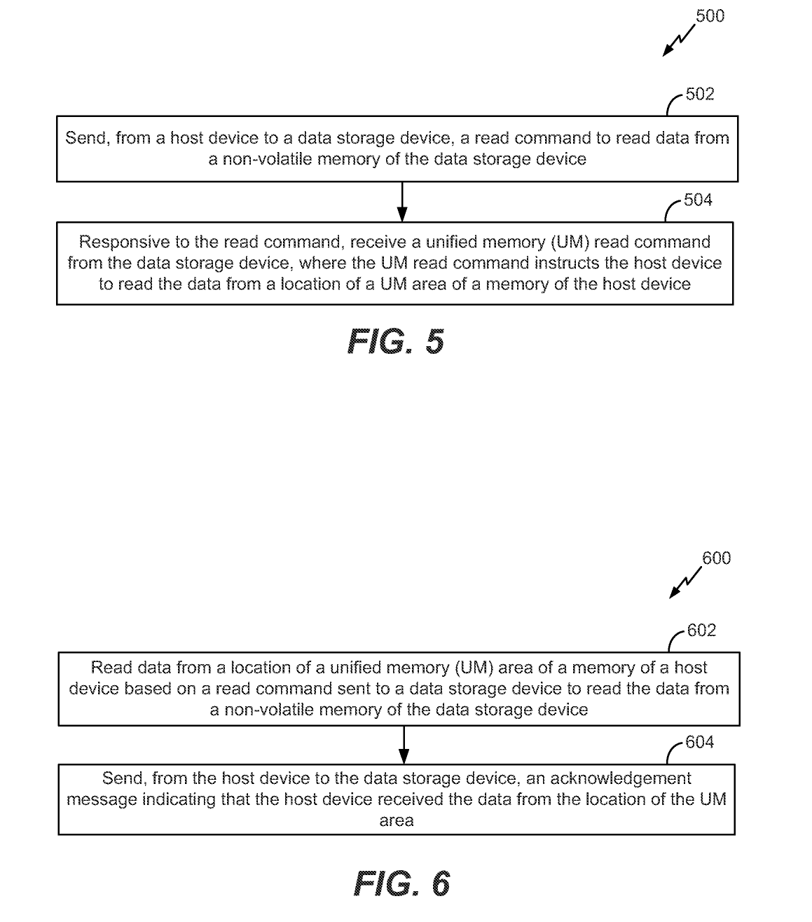

Referring to FIG. 5, an illustrative embodiment of a method 500 to enable access from unified memory (UM) area is shown. For example, the method 500 may be performed by the host device 130 of FIG. 1 or the host device 202 of FIG. 2.

The method 500 includes sending, from the host device to a data storage device, a read command to read data from a non-volatile memory of the data storage device, at 502. The read command may include or correspond to the read command 144 of FIG. 1. The read command may include a small computer system interface (SCSI) read command. The read command may include a logical address that corresponds to a physical address of the non-volatile memory that stores the data. The data stored in the non-volatile memory may include or correspond to the data 156 of the non-volatile memory 104 of FIG. 1. The non-volatile memory of the data storage device may include or correspond to the non-volatile memory 104 of the data storage device 102 of FIG. 1 or a non-volatile memory of the data storage device 204 of FIG. 2. The host device and the data storage device may be configured to communicate using a universal flash storage (UFS) protocol, such as a UFS protocol defined by one or more JEDEC standards.

The method 500 also includes receiving a unified memory (UM) read command from the data storage device responsive to the read command, where the UM read command instructs the host device to read the data from a location of a UM area of a memory of the host device, at 504. The UM read command may include or correspond to the UM read command 146 of FIG. 1. The UM area of the memory of the host device may include or correspond to the UM area 138 of the memory 134 of FIG. 1. The UM read command may include a pointer that indicates the UM address of the UM area, the UM address of the UM area, an amount (e.g., a size) of data to be read from the UM area, or a combination thereof. The UM read command, such as the UM read command 146 of FIG. 1, may enable the host device to directly access the data from the UM area of the memory of the host device. For example, the UM read command may enable the host device to read the data from the location of the UM area to complete execution of the read command without sending the data read from the location of the UM area to the data storage device after the host device receives the data from the UM area. The UM read command may include or correspond to a “virtual” data in universal flash storage (UFS) protocol information unit (UPIU) command. A format of the UM read command may be defined by one or more JEDEC standards.

The method 500 may enable the host device to (directly) access the data stored at the UM area of the host device. Accordingly, the data storage device may store the data, such as predicted data (e.g., read ahead data or pre-fetch data) at the UM area of the host device without increasing a latency associated with providing the data to the host device responsive to the read request.

Referring to FIG. 6, an illustrative embodiment of a method 600 to enable acknowledgement of data accessed from a unified memory (UM) area is shown. For example, the method 600 may be performed by the host device 130 of FIG. 1 or the host device 202 of FIG. 2.

The method 600 includes reading data from a location of a unified memory (UM) area of a memory of the host device based on a read command sent to a data storage device to read the data from a non-volatile memory of the data storage device, at 602. The location may correspond to an address (e.g., a UM address) of the UM area. The UM area of the memory of the host device may include or correspond to the UM area 138 of the memory 134 of the host device 130 of FIG. 1. The data storage device may include or correspond to the data storage device 102 of FIG. 1 or the data storage device 204 of FIG. 2. The read command to read the data from the non-volatile memory may include or correspond to the read command 144 to read the data 156 from the non-volatile memory 104 of FIG. 1. The host device and the data storage device may be configured to communicate using a universal flash storage (UFS) protocol, such as a UFS protocol defined by one or more JEDEC standards.

The method 600 further includes sending, from the host device to the data storage device, an acknowledgement message indicating that the host device received the data from the location of the UM area, at 604. The acknowledgement message may indicate that the host device read the first data and that the UM address (e.g., a location) of the UM area as available. The acknowledgment message (e.g., an acknowledge UM read message) may include or correspond to the acknowledge message 148 of FIG. 1. A format of the acknowledgement message may be defined by one or more JEDEC standards.

The method 600 may enable the data storage device to update a UM tracking table based on the acknowledgement message. Accordingly, based on the acknowledgement message, the data storage device may be informed that the host device received the data (e.g., predicted data) from the UM area and may determine that the data stored at the UM area may be overwritten (e.g., the data is no longer needed to be stored at the UM area). Additionally, based on the acknowledgement message, the data storage device may track available storage space (e.g., available storage locations) at the UM area.

The method 200 of FIG. 2, the method 300 of FIG. 3, the method 400 of FIG. 4, the method 500 of FIG. 5, and/or the method 600 of FIG. 6 may be initiated or controlled by an application-specific integrated circuit (ASIC), a processing unit, such as a central processing unit (CPU), a digital signal processor (DSP), a controller, another hardware device, a firmware device, a field-programmable gate array (FPGA) device, or any combination thereof. As an example, the method 200 of FIG. 2, the method 300 of FIG. 3, the method 400 of FIG. 4, the method 500 of FIG. 5, and/or the method 600 of FIG. 6 can be initiated or controlled by one or more processors included in or coupled to the data storage device 102 of FIG. 1, such as one or more processors included in or coupled to the controller 120 of FIG. 1, one or more processors included in or coupled to the host device 130 (e.g., the processor 132) of FIG. 1, and/or one or more processors included in or coupled to the host device 202 or the data storage device 204 of FIG. 2.

A controller configured to perform the method 200 of FIG. 2, the method 300 of FIG. 3, the method 400 of FIG. 4, the method 500 of FIG. 5, and/or the method 600 of FIG. 6 may be able to advantageously enable a unified memory architecture (UMA) enhancement for universal flash storage (UFS) commands. Although various components of the data storage device 102 and the host device 130 depicted herein are illustrated as block components and described in general terms, such components may include one or more microprocessors, state machines, or other circuits configured to enable the controller 120 and/or the processor 132 of FIG. 1 to perform operations described herein. One or more aspects of the controller 120 and/or the processor 132 may be implemented using a microprocessor or microcontroller programmed to perform operations described herein, such as one or more operations of the method 200 of FIG. 2, the method 300 of FIG. 3, the method 400 of FIG. 4, the method 500 of FIG. 5, and/or the method 600 of FIG. 6. In a particular embodiment, the controller 120 and/or the processor 132 includes a processor executing instructions that are stored at a memory, such as a non-volatile memory of the data storage device 102 or the host device 130. Alternatively or additionally, executable instructions that are executed by the processor may be stored at a separate memory location that is not part of the non-volatile memory, such as at a read-only memory (ROM) of the data storage device 102 or the host device 130.

In an illustrative example, the processor may execute the instructions to receive, from the host device, a read command to read data from a non-volatile memory of a data storage device. The instructions to receive the read command may include instructions to parse the read command, instructions to identify a logical address (e.g., a logical block address) included in the read command, instructions to determine an amount of data to be read, instructions to identify a location of a mapping table, instructions to access the mapping table, and/or instructions to translate the logical address to a physical address of a memory of the data storage device, as illustrative, non-limiting examples. The processor may execute instructions to send a UM read command to the host device responsive to the read command. The UM read command may instruct the host device to read the data from a location of the UM area. The instructions to send the UM read command may include instructions to determine whether data to be read responsive to the read command is stored at a unified memory (UM) area of the host device, instructions to access a UM tracking table, instructions to identify a UM address of the UM area of the host device, instructions to determine an amount of data for the host device to read, and/or instructions to generate the UM read command, as illustrative, non-limiting examples.

In another illustrative example, the processor may execute the instructions to receive, from a host device, an acknowledgement message indicating that the host device received data from a location of a unified memory (UM) area of the host device. The instructions to receive the acknowledgement message may include instructions to parse the acknowledgment message and/or instructions to identify a storage location of the UM area associated with the acknowledgment message, as illustrative, non-limiting examples. The processor may execute instructions to identify the location of the UM area as available based on the acknowledgement message. The instructions to identify the location as available may include instructions to access a UM tracking table, instructions to identify a portion of the UM tracking table corresponding to the location of the UM associated with the acknowledgement message, and/or instructions to indicate that the location of the UM area is available to store other data, as illustrative, non-limiting examples.

The data storage device 102 may be attached to or embedded within one or more host devices, such as within a housing of a host communication device, which may correspond to the host device 130. The data storage device 102 may be within a packaged apparatus such as a wireless telephone, a personal digital assistant (PDA), a gaming device or console, a portable navigation device, a computer device (e.g., a tablet or a laptop), or other device that uses internal non-volatile memory. However, in other embodiments, the data storage device 102 may be a portable device configured to be selectively coupled to one or more external devices, such as the host device 130. For example, the data storage device 102 may be a removable device such as a Universal Serial Bus (USB) flash drive or a removable memory card, as illustrative examples.

In an illustrative example, the processor may execute the instructions to send, to a data storage device, a read command to read data from a non-volatile memory of the data storage device. The instructions to send the read command may include instructions to determine a logical block address range (e.g., a logical address) to be read, instructions to determine an amount of data to be read, and/or instructions to generate the read command, as illustrative, non-limiting examples. The processor may execute instructions to receive a unified memory (UM) read command from the data storage device responsive to the read command. The UM read command may instruct a host device to read the data from a location of a UM area of the host device. The instructions to receive the UM command may include instructions to parse the UM read command, instructions to determine a storage location of a unified memory (UM) area based on the UM read command, instructions to determine an amount of data to be read based on the UM read command, instructions to read data from the storage location, instructions to provide the data to a processor of the host device, and/or instructions to generate an acknowledgement message associated with the storage location, as illustrative, non-limiting examples.

In another illustrative example, the processor may execute the instructions to read data from a location of a unified memory (UM) area of a host device based on a read command sent to a data storage device to read the data from a non-volatile memory of the data storage device. The instructions to read the data from the location of the UM area may include instructions to receive a UM command, instructions to parse the UM read command, instructions to determine a storage location of a unified memory (UM) area based on the UM read command, instructions to determine an amount of data to be read based on the UM read command, instructions to read data from the storage location, and/or instructions to provide the data to a processor of the host device, as illustrative, non-limiting examples. The processor may execute instructions to send, to the data storage device, an acknowledgement message indicating that the host device received the data from the location of the UM area. The instructions to send the acknowledgement message may include instructions to identify the storage location of the UM area, instructions to confirm receipt of the data from the UM area, instructions to determine whether a response message is received from the data storage device, and/or instructions to generate the acknowledgement message, as illustrative, non-limiting examples.

The host device 130 may correspond to a mobile telephone, a music player, a video player, a gaming device or console, an electronic book reader, a personal digital assistant (PDA), a computer, such as a laptop, a tablet, or a notebook computer, a portable navigation device, another electronic device, or a combination thereof. The host device 130 may communicate via a host controller, which may enable the host device 130 to communicate with the data storage device 102. The host device 130 may operate in compliance with a JEDEC Solid State Technology Association industry specification, such as an embedded MultiMedia Card (eMMC) specification or a Universal Flash Storage (UFS) Host Controller Interface specification. The host device 130 may operate in compliance with one or more other specifications, such as a Secure Digital (SD) Host Controller specification, as an illustrative example. Alternatively, the host device 130 may communicate with the data storage device 102 in accordance with another communication protocol.

The data storage device 102 may be configured to be coupled to the host device 130 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

Semiconductor memory devices, such as the memory 104, the RAM 122, and/or the memory 134, include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., in a NOR memory array. NAND and NOR memory configurations described have been presented as examples, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor material, such as silicon.

The memory elements may be arranged in the single memory device level in an ordered array, such as in a plurality of rows and/or columns. However, the memory elements may be arranged in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration (e.g., in an x-z plane), resulting in a three dimensional arrangement of memory elements with elements arranged on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device level. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor material, such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Two dimensional arrays may be formed separately and then packaged together to form a non-monolithic memory device having multiple layers of memory. For example, non-monolithic stacked memories can be constructed by forming memory levels on separate substrates and then stacking the memory levels atop each other. To illustrate, each of the memory device levels may have a corresponding substrate thinned or removed before stacking the memory device levels to form memory arrays. Because each of the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

In some implementations, the memory 104, the RAM 122, and/or the memory 134 is a non-volatile memory having a three-dimensional (3D) memory configuration that is monolithically formed in one or more physical levels of arrays of memory cells having an active area disposed above a silicon substrate. The active area of a memory cell may be an area of the memory cell that is conductively throttled by a charge trap portion of the memory cell. The data storage device 102 and/or the host device 130 may include circuitry, such as read/write circuitry, as an illustrative, non-limiting example, associated with operation of the memory cells.

Associated circuitry is typically used for operation of the memory elements and for communication with the memory elements. As non-limiting examples, memory devices may have circuitry for controlling and driving memory elements to perform functions such as programming and reading. The associated circuitry may be on the same substrate as the memory elements and/or on a separate substrate. For example, a controller for memory read-write operations may be located on a separate controller chip and/or on the same substrate as the memory elements.

One of skill in the art will recognize that this disclosure is not limited to the two dimensional and three dimensional structures described but cover all relevant memory structures within the spirit and scope of the disclosure as described herein and as understood by one of skill in the art.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
in a data storage device including a non-volatile memory, the data storage device coupled to a host device that includes a memory having a unified memory (UM) area, performing:
receiving, from the host device, a read command to read data from the non-volatile memory; and
responsive to the read command, sending a UM read command to the host device, wherein the UM read command instructs the host device to read the data from a location of the UM area.

2. The method of claim 1, wherein the UM read command enables the host device to directly access the data from the UM area of the memory of the host device.

3. The method of claim 1, further comprising:
identifying the data stored at a storage location of the non-volatile memory as predicted data prior to sending a UM write command to the host device; and
sending the UM write command to the host device based on the data being identified as the predicted data.

4. The method of claim 3, wherein the predicted data comprises read ahead data or pre-fetch data.

5. The method of claim 1, further comprising:
reading the data from a storage location of the non-volatile memory; and
prior to receiving the read command, sending a UM write command to the host device to write the data to the UM area of the memory of the host device.

6. The method of claim 1, further comprising:
in response to receiving the read command, determining whether the data is stored at the UM area based on a UM tracking table, wherein the UM tracking table tracks storage locations associated with the UM area; and
when the data is determined to be stored at the UM area, determining the location of the UM area that stores the data.

7. The method of claim 1, further comprising after the data is determined to be stored at the UM area, determining the location of the UM area that stores the data.

8. The method of claim 1, further comprising, after sending the UM read command, receiving an acknowledgment message from the host device, wherein the acknowledgement message indicates that the host device received the data from the location of the UM area.

9. The method of claim 1, wherein the non-volatile memory includes a three-dimensional (3D) memory configuration that is monolithically formed in one or more physical levels of arrays of memory cells having an active area disposed above a silicon substrate, and wherein the data storage device includes circuitry associated with operation of the memory cells.

10. A method comprising:
in a data storage device including a non-volatile memory, the data storage device coupled to a host device that includes a memory having a unified memory (UM) area, performing:
receiving, from the host device, an acknowledgement message indicating that the host device received data from a location of the UM area; and
identifying the location of the UM area as available based on the acknowledgement message.

11. The method of claim 10, wherein the acknowledgement message is responsive to a UM read command sent from the data storage device to the host device.

12. The method of claim 10, wherein the acknowledgement message comprises an acknowledge UM read message.

13. The method of claim 12, wherein the data storage device instructs the host device to read the data from the location of the UM area based on a read command sent from the host device to the data storage device.

14. The method of claim 10, wherein the non-volatile memory includes a three-dimensional (3D) memory configuration that is monolithically formed in one or more physical levels of arrays of memory cells having an active area disposed above a silicon substrate, and wherein the data storage device includes circuitry associated with operation of the memory cells.

15. A data storage device comprising:
a non-volatile memory including a plurality of storage locations; and
a controller operatively coupled to the non-volatile memory, wherein the controller is configured to receive a read command from a host device that includes a memory having a unified memory (UM) area, wherein the controller is configured to send a UM read command to the host device responsive to the read command, and wherein the UM read command instructs the host device to read data from a location of the UM area.

16. The data storage device of claim 15, wherein the UM read command enables the host device to read the data from the UM area to complete execution of the read command without sending the data read from the UM area to the data storage device after the host device receives the data from the UM area.

17. The data storage device of claim 15, wherein the UM read command comprises a virtual data in universal flash storage (UFS) protocol information unit (UPIU).

18. The data storage device of claim 15, wherein the UM read command indicates an address of the UM area and a size of the data stored at the UM area.

19. The data storage device of claim 15, wherein the non-volatile memory includes a three-dimensional (3D) memory configuration that is monolithically formed in one or more physical levels of arrays of memory cells having an active area disposed above a silicon substrate, and further comprising circuitry associated with operation of the memory cells.

20. A data storage device comprising:
a non-volatile memory including a plurality of storage locations; and
a controller operatively coupled to the non-volatile memory, wherein the controller is configured to receive, from a host device that includes a memory having a unified memory (UM) area, an acknowledgement message indicating that the host device received data from a location of the UM area, and wherein the controller is configured to identify the location of the UM area as available based on the acknowledgement message.

21. The data storage device of claim 20, wherein the controller is configured to maintain a UM tracking table that tracks storage locations associated with the UM area, and wherein the controller updates the UM tracking table to identify the location of the UM area as available.

22. The data storage device of claim 20, wherein the non-volatile memory includes a three-dimensional (3D) memory configuration that is monolithically formed in one or more physical levels of arrays of memory cells having an active area disposed above a silicon substrate, and further comprising circuitry associated with operation of the memory cells.

23. A method comprising:
in a host device including a memory having a unified memory (UM) area, the host device coupled to a data storage device that includes a non-volatile memory, performing:
sending, to the data storage device, a read command to read data from the non-volatile memory; and
responsive to the read command, receiving a UM read command from the data storage device, wherein the UM read command instructs the host device to read the data from a location of the UM area.

24. The method of claim 23, further comprising identifying a pointer included in the UM read command that indicates the location of the UM area, a size of the data stored at the UM area, or a combination thereof.

25. The method of claim 23, wherein the read command comprises a small computer system interface (SCSI) read command.

26. The method of claim 23, wherein the memory includes a three-dimensional (3D) memory configuration that is monolithically formed in one or more physical levels of arrays of memory cells having an active area disposed above a silicon substrate, and wherein the host device includes circuitry associated with operation of the memory cells.

27. A method comprising:
in a host device including a memory having a unified memory (UM) area, the host device coupled to a data storage device that includes a non-volatile memory, performing:
reading data from a location of the UM area based on a read command sent to the data storage device to read the data from the non-volatile memory of the data storage device; and
sending, to the data storage device, an acknowledgement message indicating that the host device received the data from the location of the UM area.

28. The method of claim 27, wherein communication between the host device and the data storage device occurs using a universal flash storage (UFS) protocol.

29. The method of claim 27, wherein the acknowledgement message indicates the location of the UM area as available.

30. The method of claim 27, wherein the memory included in the host device includes a three-dimensional (3D) memory configuration that is monolithically formed in one or more physical levels of arrays of memory cells having an active area disposed above a silicon substrate, and wherein the host device includes circuitry associated with operation of the memory cells.
